(19) United States
(12) Patent Application Publication
(10) Pub. No.: US 2010/0093906 A1
(43) Pub. Date: Apr. 15, 2010

(54) Active Substance Composition On This Basis Of Metallocene Polyolefin Waxes For Producing Stabilized, Light-Resistant Plastic Materials

(75) Inventor: Reinhold Kling, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Finance (BVI) Limited, Tortola (VG)

(21) Appl. No.: 12/444,770

(22) PCT Filed: Oct. 4, 2007
(86) PCT No.: PCT/EP2007/008591

§ 371 Date: Apr. 8, 2009

(30) Foreign Application Priority Data
Oct. 10, 2006 (DE) 10 2006 047 854.1

(51) Int. Cl. C08K 5/56; B29C 47/08

(52) U.S. Cl. 524/394; 264/145

(57) ABSTRACT

The invention relates to an active substance composition containing a high portion of one or more light-protecting products, such as multifunctional stabilizers, UV absorbers, nicker-quenchers and stabilizers on the basis of sterically hindered amines (HALS) and several polyolefin waxes, wherein one or more metallocene polyolefin waxes are used and optionally further waxes, for example polar or nonpolar non-metallocene polyolefin waxes are present. All polyolefin waxes together made up at least 10% by weight of the formulation and melt in the temperature range between 50 and 170° C. The inventive active substance composition has reduced dusting and is particularly used for the masterbatch production for producing stabilized and light-resistant plastic materials.

The present invention relates to active substance compositions comprising light stabilizers, especially UV stabilizers, and waxes and also to their preparation and use.

UV stabilizers comprehend a very wide variety of product classes such as, for example, UV absorbers, HALS products (hindered amine light stabilizers) or else quenchers.

The active substance compositions of the invention comprise waxes which have been prepared by means of metallocene catalysts, and which have a low dropping point, a high transparency, and low viscosity. As a result of the use of these waxes, the incorporation of UV stabilizers is facilitated; the operating temperatures can be kept significantly lower, and so a significantly higher loading than has hitherto been customary is possible, and there is no need for a polymeric carrier.

JP 2005054019 describes the production of exterior automotive components which comprise UV absorbers and HALS in fractions of up to 15 parts, and also up to 5 parts of antioxidants.

CN 1174855 discloses the production of a polyolefin masterbatch which comprises light sensitizers, light stabilization, antioxidants, and starch.

CN 1109479 describes the production of an aging inhibitor masterbatch based on polyolefin, which is admixed with process assistants at up to 2.5% by weight, up to 5% to 20% by weight of sebacates, and 1% to 10% by weight of tris-phosphites.

In the applications cited, additives, UV absorbers, and HALS products are added only up to about 25% by weight; higher added quantities are not found in the literature.

One possible way of increasing the added quantities would be, with a high-porosity raw material of costly and inconvenient preparation, to incorporate liquid or low-melting light stabilizers by stirring, and to draw them into the product with the aid of reduced pressure. This very special operation entails significantly higher costs and is limited in its applicability.

UV masterbatches produced by customary methods customarily contain not more than 10% by weight of UV or HALS products. Higher added quantities may, as a result of the difference in viscosity, lead to incorporation problems, to an uneven distribution of the components, and to reduced mechanical properties, such as lower strand strength in the masterbatches produced, for example.

One possible way of increasing the amount of active substance in the masterbatch would be to use special low-viscosity polymers, which accordingly have good processing properties at lower temperatures and allow the incorporation of a greater quantity of additive. Technical polymers which exhibit this profile of properties are usually classed in the high-price segment.

It was an object of the present invention to prepare active substance compositions with a very high fraction of UV stabilizers, in order to bring about, advantageously, the production of plastic-material components with high thermal stability, low discoloration tendencies, and good long-term behavior, technically, economically, and environmentally, and so to produce products of high quality. Furthermore, such compositions can be incorporated into a relatively large diversity of polymers with different chemical compositions, since there are fewer compatibility problems, as a result of the smaller amount of carrier material (the wax). The wax component, moreover, allows easier incorporation and distribution of the active substance composition in the polymers.

Among the waxes a distinction is made between essentially two groups: waxes prepared using metallocene catalysts (metallocene waxes), and those prepared in another way, such as by a molecular enlargement reaction using other catalysts, for example, or else those prepared, for example, by degradation reactions of polymers.

Surprisingly it has now been found that polyolefin waxes, especially polypropylene waxes, prepared using metallocene catalysts have especially advantageous suitability as carriers for UV stabilizers, allowing significantly higher loadings than was hitherto customarily the case.

This object is achieved in accordance with the invention by incorporating the UV stabilizers into a metallocene wax or into a mixture of different metallocene waxes, optionally comprising one or more nonmetallocene waxes and/or polymers, the predominant fraction being composed of metallocene wax. These types of wax used in accordance with the invention have been prepared in the presence of metallocene catalysts.

The present invention accordingly provides a light-resistant active substance composition comprising
i) one or more UV stabilizers,
ii) one or more metallocene polyolefin waxes,
iii) optionally, one or more waxes selected from polar and apolar nonmetallocene polyolefin waxes, and
iv) if desired, one or more homopolymers and/or copolymers of ethylene and/or of propylene,
   wherein it comprises UV stabilizers in an amount of at least 10% to 90% by weight and at least 10% by weight of wax, based in each case on the total weight of the composition. In the preferred embodiment the wax contains at least 50% by weight of polypropylene metallocene wax, based on the weight of the total wax fraction.

In addition to the metallocene polyolefin wax, the composition of the invention may preferably further comprise one or more metallocene copolymer waxes of propylene and 0.1% to 50% of ethylene and/or 0.1% to 50% of at least one branched or unbranched 1-alkene having 4 to 20 carbon atoms, with a dropping point (ring/ball) of between 80 and 170° C. The metallocene waxes used in accordance with the invention have a melt viscosity, measured at a temperature of 170° C., in the range from 40 to 80 000 mPa·s, preferably from 45 to 35 000 mPa·s, more preferably from 50 to 10 000 mPa·s.

The waxes and/or the homopolymers and/or copolymers of ethylene and/or of propylene of the components ii), iii) and iv) melt at a temperature in the range from 80 to 170° C.

The waxes prepared in the presence of metallocene as catalyst are largely or entirely amorphous and may additionally, if necessary, have been given a polar modification.

Suitable nonmetallocene polyolefin waxes are apolar but also polar, nonmetallocene waxes selected from oxidized and nonoxidized waxes, having a dropping point in the range from 90 to 130° C. and a viscosity of less than 30 000 mPa·s, preferably less than 15 000 mPa·s, at a temperature of 140° C.

Suitable nonmetallocene polyolefin waxes are homopolymers of ethylene or of higher 1-olefins having 3 to 10 carbon atoms, or their copolymers with one another. The polyolefin waxes preferably have a weight-average molar mass M_{w}, of between 1000 and 20 000 g/mol and a number-average molar mass Mₙ of between 500 and 15 000 g/mol.

Additionally it is possible for copolymers and/or homopolymers of ethylene and/or of propylene to be used advantageously as compatibilizers in the composition of the invention. Suitable copolymers of ethylene here, for example, are ethylene-methyl acrylate copolymers, ethylene-ethyl acrylate copolymers, ethylene-butyl acrylate copolymers or ethylene-vinyl acetate copolymers.

Ethylene-methyl acrylate copolymers are especially suitable as copolymers of propylene.

These products typically possess a softening point of less than 60° C., a melting temperature of less than 100° C., a comonomer fraction of 10% to 20%, and a melt index of 190° C. and 2.16 kg of 1 to 10 g/10 min. In the further course of the description they are referred to as “copolymers of ethylene or of propylene”.

Mixtures preferred in accordance with the invention contain 10% to 90% by weight of light stabilizers, preferably 15% to 85% by weight, in particular 25% to 85% by weight, and also 10% to 90% by weight, preferably 15% to 85% by weight, of a metallocene polyolefin wax. Additionally it is possible for further stabilizers, organic and/or inorganic pigments, adjuvants, fillers such as silicates, nanoclays, silicas, and zeolites to be present at between 0% to 30% by weight. A listing of suitable adjuvants is found, for example, in “Plastics Additives Handbook”, 5th edition (2000), Hanser-Verlag.

In one preferred embodiment the composition of the invention contains 10% to 90% by weight, preferably 15% to 85% by weight, of the metallocene polyolefin wax, 0% to 30% by weight, preferably 0.1% to 25% by weight, of one or more nonmetallocene waxes and/or homopolymers and/or copolymers of ethylene and/or of propylene, 10% to 90% by weight, preferably 15% to 85% by weight, of one or more UV stabilizers, and 0% to 30% by weight of further fillers, pigments or additives.

The metallocene polyolefin waxes used in accordance with the invention are prepared using metallocene compounds of the formula I.

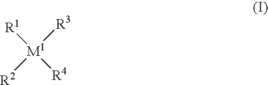

This formula also encompasses compounds of the formula Ia,

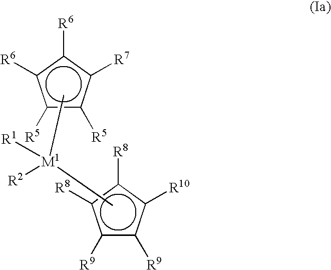

of the formula Ib

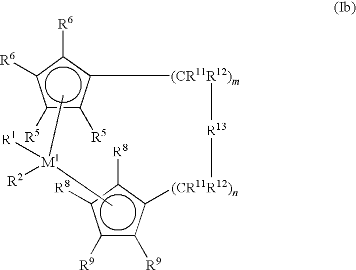

and of the formula Ic

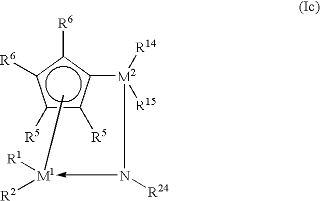

In the formulae I, Ia, and Ib, M¹ is a metal from group IVb, Vb or VIb of the Periodic Table of the Elements, examples being titanium, zirconium, hafnium, vanadium, niobium, tantalum, chromium, molybdenum, and tungsten, preferably titanium, zirconium, and hafnium.

R¹ and R² are alike or different and are a hydrogen atom, a C₁-C₁₀, preferably C₁-C₃ alkyl group, especially methyl, a C₁-C₁₀, preferably C₁-C₃ alkoxy group, a C₆-C₁₀, preferably C₆-C₈ aryl group, a C₆-C₁₀, preferably C₆-C₈ aryloxy group, a C₂-C₁₀, preferably C₂-C₄ alkenyl group, a C₇-C₄₀, preferably C₇-C₁₀ arylalkyl group, a C₇-C₄₀, preferably C₇-C₁₂ alkylaryl group, a C₈-C₄₀, preferably C₈-C₁₂ arylalkenyl group or a halogen atom, preferably chlorine atom.

R³ and R⁴ are alike or different and are a mono- or polycyclic hydrocarbon radical which is able to form a sandwich structure with the central atom M¹. R³ and R⁴ are preferably cyclopentadienyl, indenyl, tetrahydroindenyl, benzoindenyl or fluorenyl, it being possible for the parent structures to carry additional substituents or to be bridged with one another. In addition it is possible for one of the radicals R³ and R⁴ to be a substituted nitrogen atom, in which case R²⁴ has the definition of R¹⁷ and is preferably methyl, tert-butyl or cyclohexyl.

R⁵, R⁶, R⁷, R⁸, R⁹, and R¹⁰ are alike or different and are each a hydrogen atom, a halogen atom, preferably a fluorine, chlorine or bromine atom, a C₁-C₁₀, preferably C₁-C₄ alkyl group, a C₆-C₁₀, preferably C₆-C₈ aryl group, a C₁-C₁₀, preferably C₁-C₃ alkoxy group, a radical —NR¹⁶₂, —SR¹⁶, —OSiR¹⁶₃, —SiR¹⁶₃ or —PR¹⁶₂, in which R¹⁶ is a C₁-C₁₀, preferably C₁-C₃ alkyl group or C₆-C₁₀, preferably C₆-C₈ aryl group or else, in the case of radicals containing Si or P, is a halogen atom, preferably chlorine atom, or pairs of adjacent radicals R⁵, R⁶, R⁷, R⁸, R⁹ or R¹⁰ form a ring with the carbon atoms connecting them. Particularly preferred ligands are the substituted compounds of the parent structures cyclopentadienyl, indenyl, tetrahydroindenyl, benzoindenyl or fluorenyl.

R¹³ is

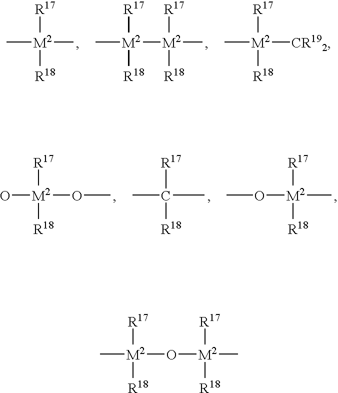

=BR¹⁷, =AlR¹⁷, —Ge—, —Sn—, —O—, —S—, ═SO, ═SO₂, ═NR¹⁷, ═CO, ═PR¹⁷ or ═P(O)R¹⁷, where R¹⁷, R¹⁸, and R¹⁹ are alike or different and are each a hydrogen atom, a halogen atom, preferably a fluorine, chlorine or bromine atom, a C₁-C₃₀, preferably C₁-C₄ alkyl, especially methyl group, a C₁-C₁₀ fluoroalkyl, preferably CF₃ group, a C₆-C₁₀ fluoroaryl, preferably pentafluorophenyl group, a C₆-C₁₀, preferably C₆-C₈ aryl group, a C₁-C₁₀, preferably C₁-C₄ alkoxy, especially methoxy group, a C₂-C₁₀, preferably C₂-C₄ alkenyl group, a C₇-C₄₀, preferably C₇-C₁₀ aralkyl group, a C₈-C₄₀, preferably C₈-C₁₂ arylalkenyl group or a C₇-C₄₀, preferably C₇-C₁₂ alkylaryl group, or R¹⁷ and R¹⁸ or R¹⁷ and R¹⁹ each form a ring together with the atoms connecting them.

M² is silicon, germanium or tin, preferably silicon and germanium. R¹³ is preferably ═CR¹⁷R¹⁸, ═SiR¹⁷R¹⁸, ═GeR¹⁷R¹⁸, —O—, —S—, ═SO, —PR¹⁷ or ═P(O)R¹⁷.

R¹¹ and R¹² are alike or different and have the definitions stated for R¹⁷, m and n are alike or different and are zero, 1 or 2, preferably zero or 1, with m plus n being zero, 1 or 2, preferably zero or 1.

R¹⁴ and R¹⁵ have the definition of R¹⁷ and R¹⁸.

Examples of suitable metallocenes are as follows:
bis(1,2,3-trimethylcyclopentadienyl)zirconium dichloride,
bis(1,2,4-trimethylcyclopentadienyl)zirconium dichloride,
bis(1,2-dimethylcyclopentadienyl)zirconium dichloride,
bis(1,3-dimethylcyclopentadienyl)zirconium dichloride,
bis(1-methylindenyl)zirconium dichloride,
bis(1-n-butyl-3-methylcyclopentadienyl)zirconium dichloride,
bis(2-methyl-4,6-diisopropylindenyl)zirconium dichloride,
bis(2-methylindenyl)zirconium dichloride,
bis(4-methylindenyl)zirconium dichloride,
bis(5-methylindenyl)zirconium dichloride,
bis(alkylcyclopentadienyl)zirconium dichloride,
bis(alkylindenyl)zirconium dichloride,
bis(cyclopentadienyl)zirconium dichloride,
bis(indenyl)zirconium dichloride,
bis(methylcyclopentadienyl)zirconium dichloride,
bis(n-butylcyclopentadienyl)zirconium dichloride,
bis(octadecylcyclopentadienyl)zirconium dichloride,
bis(pentamethylcyclopentadienyl)zirconium dichloride,
bis(trimethylsilylcyclopentadienyl)zirconium dichloride,
biscyclopentadienylzirconium dibenzyl,
biscyclopentadienylzirconium dimethyl,
bistetrahydroindenylzirconium dichloride,
dimethylsilyl-9-fluorenylcyclopentadienylzirconium dichloride,
dimethylsilylbis-1-(2,3,5-trimethylcyclopentadienyl)zirconium dichloride,
dimethylsilylbis-1-(2,4-dimethylcyclopentadienyl)zirconium dichloride,
dimethylsilylbis-1-(2-methyl-4,5-benzoindenyl)zirconium dichloride,
dimethylsilybis-1-(2-methyl-4-ethylindenyl)zirconium dichloride,
dimethylsilylbis-1-(2-methyl-4-isopropylindenyl)zirconium dichloride,
dimethylsilylbis-1-(2-methyl-4-phenylindenyl)zirconium dichloride,
dimethylsilylbis-1-(2-methylindenyl)zirconium dichloride,
dimethylsilylbis-1-(2-methyltetrahydroindenyl)zirconium dichloride,
dimethylsilylbis-1-indenylzirconium dichloride,
dimethylsilylbis-1-indenylzirconium dimethyl,
dimethylsilylbis-1-tetrahydroindenylzirconium dichloride,
diphenylmethylene-9-fluorenylcyclopentadienylzirconium dichloride,
diphenylsilylbis-1-indenylzirconium dichloride,
ethylenebis-1-(2-methyl-4,5-benzoindenyl)zirconium dichloride,
ethylenebis-1-(2-methyl-4-phenylindenyl)zirconium dichloride,
ethylenebis-1-(2-methyltetrahydroindenyl)zirconium dichloride,
ethylenebis-1-(4,7-dimethylindenyl)zirconium dichloride,
ethylenebis-1-indenylzirconium dichloride,
ethylenebis-1-tetrahydroindenylzirconium dichloride,
indenylcyclopentadienylzirconium dichloride,
isopropylidene(1-indenyl)(cyclopentadienyl)zirconium dichloride,
   isopropylidene(9-fluorenyl)(cyclopentadienyl)zirconium dichloride,
phenylmethylsilylbis-1-(2-methylindenyl)zirconium dichloride,
   and also in each case the alkyl or aryl derivatives of these metallocene dichlorides.

The single-center catalyst systems are activated using suitable cocatalysts. Suitable cocatalysts for metallocenes of the formula I are organoaluminum compounds, especially alumoxanes, or else aluminum-free systems such as R²⁰ₓNH₄₋ₓBR²¹₄, R²⁰ₓPH₄₋ₓBR²¹₄, R²⁰₃CBR²¹₄ or BR²¹₃. In these formulae, x is a number from 1 to 4, the radicals R²⁰ are alike or different, preferably alike, and are C₁-C₁₀ alkyl or C₆-C₁₈ aryl, or two radicals R²⁰ form a ring together with the atom connecting them, and the radicals R²¹ are alike or different, preferably alike, and are C₆-C₁₈ aryl which may be substituted by alkyl, haloalkyl or fluorine. In particular R²⁰ is ethyl, propyl, butyl or phenyl and R²¹ is phenyl, pentafluorophenyl, 3,5-bistrifluoromethylphenyl, mesityl, xylyl or tolyl.

Frequently a third component is necessary in addition in order to ensure protection against catalyst poisons. Suitability for this purpose is possessed by organoaluminum compounds such as, for example, triethylaluminum, tributylaluminum, and others, and also mixtures.

Depending on the process it is also possible for supported single-center catalysts to be used. Preference is given to catalyst systems in which residues of support material and cocatalyst do not exceed a concentration of 100 ppm in the product.

The melt viscosities here were determined to DIN 53019 using a rotary viscometer, the dropping points to DIN 51801/2, and the ring/ball softening points to DIN EN 1427. The dropping point is determined using an Ubbelohde dropping point instrument to DIN 51801/2, the ring/ball softening point to DIN EN 1427.

UV stabilizers which can be used are primarily three different classes of product: sterically hindered amines (HALS), nickel quenchers and/or UV absorbers. Also possible are combinations of different HALS, nickel quenchers or UV absorbers, and also mixtures of the products with one another. This relates to all of the products cited in “Plastics Additives Handbook”, 5th edition (2000), Hanser-Verlag pages 114-136.

UV stabilizers that can be used in accordance with the invention are specified in EP-B-981530 (page 5 line 7 to page 28 line 30). EP-A-981530 is hereby expressly incorporated by reference. Preference is given to compounds as described in EP-B-981530 at page 13 lines 22 to 26 and page 28 lines 28 to 30.

Quenchers which can be used in accordance with the invention are specified in EP-B-981530 at page 42 lines 50 to 55. Particular preference is given to the compound having the CAS number 14516-71-3 (trade name Cyasorb UV-1084).

The incorporation of the UV stabilizers into the waxes takes place in accordance with the known state of the art, by combining all of the components at an elevated temperature to form a homogeneous mass and then converting that mass into a suitable end-product form. Mixtures of this kind are normally produced in an extruder or compounder, although there are other assemblies used even less often. The end-product form usually comprises granules, which are produced by strand pelletizing, hot cutting or underwater pelletizing. Of the methods known, preference is given especially to the extruder and to underwater pelletizing.

The fraction of metallocene waxes required is dependent on the processing properties and also on the granule strengths of the intermediates, the specification of the properties of the completed material, its surface qualities, and its requisite optical properties.

Besides the waxes and light stabilizers, the compositions of the invention may of course also comprise other substances, such as further processing stabilizers and phenolic antioxidants, for example, to name but a few. Particularly noteworthy here are the phenolic, phosphitic and phosphonitic antioxidants, not forgetting the secondary antioxidants.

In the case of the phenolic antioxidants this relates in particular to tetrakis[methylene(3,5-di-tert-butyl-4-hydroxyhydrocinnamate)]methane, 1,2,3-tris(3,5-di-tert-butyl-4-hydroxybenzyl) isocyanurate, octadecyl 3,5-di-tert-butyl-4-hydroxyhydrocinnamate, bis[3,3-bis(4′-hydroxy-3′-tert-butylphenyl)butanoic acid) glycol ester, mixture of tetrakis[methylene(3,5-di-tert-butyl-4-hydroxyhydrocinnamate)]methane and bis[3,3-bis(4′-hydroxy-3′-tert-butylphenyl)butanoic acid) glycol ester or ethylenebis-(oxyethylene)bis-(3-(5-tert-butyl-4-hydroxy-m-tolyl) propionate.

In the case of the phosphite and phosphonite antioxidants, mention may be made here, in particular, of tris(2,4-di-tert-butylphenyl) phosphite, bis(2,4-di-tert-butylphenyl)pentaerythritol diphosphite, and the CAS Reg. Nos 119345-01-6/38613-77-3.

In the case of the costabilizers, mention may be made here, in particular, of distearyl 3,3′-thiodipropionate and distearyl disulfide.

Further processing stabilizers and antioxidants which can be used in accordance with the invention are disclosed in EP-B-981530 (page 40 line 10 to page 42 line 17 and page 44 lines 45 to 55).

The present invention also provides a process for producing the active substance composition of the invention by combining the individual constituents and then homogenizing them in an extruder or compounder. The preliminary mixing of the individual components is preferred in the preparation of the composition and can take place in a suitable mixing apparatus; alternatively, if desired, further additives may not be added until later, via a side feed, in solid or liquid form.

The raw materials used may be present in any of a very wide variety of forms. The waxes, and also the further adjuvants and additives, may be present, for example, in the form of granules, flakes or powders, including ultrafine powders, in the mixture, while the light stabilizers may also, additionally, be present in liquid form.

For the production of dust-free, highly loaded active substance compositions in granular and powder forms, the following single-stage or multistage methods are presently known:

All of the components can be mixed cold, addition taking place via the main feed of an extruder, or the waxlike/polymeric fractions of the formulation are fed in via the main feed of the extruder, the powderous or liquid UV stabilizers being introduced into the machine via corresponding side feeds. Mixing in the melt can be carried out subsequently in a suitable extruder or in compounders. This is followed by pelletizing, grinding or spraying.

A cold mix is composed of suitable polymeric carriers, such as polyethylene, polypropylene or ethylene-vinyl acetate, for example. The disadvantage of such polymer mixtures is the often limited compatibility of individual components, in which case there may be separation of polymer and the adjuvants such as the light stabilizers.

In the case of mixing at an elevated temperature, the thermal energy may be introduced via friction, via separate heating of the mixing vessel, or in both ways.

Where the composition is produced in an extruder, it is preferred to operate with a screw structure matched to the high active substance content. The temperature profile is preferably lower than indicated in the state of the art. For producing the compositions of the invention it is advantageous to employ a strand pelletizing method, although underwater pelletizing or hot cutting can also be employed.

The compositions of the invention allow semisynthetic or synthetic polymers to be stabilized against the harmful influence of high-energy radiation such as light or UV, but also against heat, degradation by oxygen, or other degradation processes, and they are therefore used in particular for the production of UV-stable plastic materials or articles made of plastic material.

In contrast to the UV-stabilized compositions described in the prior art, the products according to the invention can be used to stabilize a broad selection of polymers. Examples include the following: polyolefins, ethylene-vinyl acetate copolymers (EVA), styrene-acrylonitrile copolymers (SAN), polyvinyl chloride (PVC), polyamide (PA), polyethylene glycol terephthalate (PET), polybutylene glycol terephthalate (PBT) and copolyesters thereof, acrylonitrile-butadiene-styrene copolymers (ABS), polycarbonate (PC), and also various specialty polymers. Also suitable, in addition, are all natural, semisynthetic or synthetic polymers, which includes coating materials as well.

After blending with the polymer and attainment of the required target concentration, the plastic-material mixtures can then be processed further to the desired end products.

### EXAMPLES

The metallocene waxes a to d used in accordance with the invention, and listed in table 1, were prepared by copolymerizing propylene with ethylene using the metallocene catalyst dimethylsilylbisindenylzirconium dichloride in accordance with the process specified in EP A 0 384 264 (general instructions, examples 1-16). The different softening points and viscosities were set by varying the ethylene feed and the polymerization temperature.

The product characteristics are determined in accordance with the following methods:

| | |
|---|---|
| Dropping point | ISO 2176//ASTM D 3954 (° C.) |
| Viscosity | DIN 53018 (mPa · s) |
| Density | ISO 1183 (g/cccm) |
| Molar mass | is determined by means of gel permeation |
| | chromatography (GPC) |

Metallocene waxes employed

| | Metallocene | Metallocene | Metallocene | Metallocene |
|---|---|---|---|---|
| | wax a) | wax b) | wax c) | wax d) |
| Dropping point | 92 | 93 | 102 | 140 |
| (° C.) | | | | |
| Viscosity at | 2900 | 7900 | 9800 | 65 |
| 170° C. | | | | |
| (mPa · s) | | | | |

Properties of the apolar PE waxes

| Dropping point | Viscosity at | Acid number | Density |
|---|---|---|---|
| [° C.] | 140° C. [mPa · s] | [mg KOH/g] | [g/cm³] |
| about 130 | about 25 000 | 0 | 0.92 |

Copolymer of ethylene

| Softening | Melting | | Comonomer | |
|---|---|---|---|---|
| point | point | Viscosity MFR | Et | Density |
| [° C.] | [° C.] | 190° C./2.16 kg | acrylate % | [g/cm³] |
| about 50-60 | about 85-98 | about 5-10 g/10 min | about 15-20 | about |
| | | | | 0.94 |

Homopolymer of ethylene

| | Melting point | Viscosity | Density |
|---|---|---|---|
| | (° C.) | 190° C./2.16 kg | (g/cm³) |
| Polyethylene | | 2 g/10 min | 0.92 |
| LDPE Sabic | | | |
| 2102 TX | | | |

The UV stabilizer composition of the invention was prepared as described below:

As the mixture for extrusion:

Mixer: Hentschel mixer, volume 5 liters
Batch: corresponding to the examples given below

Preliminary mixing: batching for about 2 to 4 min at rpm=600/min

The preliminary mixture is formed from the wax or wax/polymer mixtures; the addition of HALS and/or UV stabilizer was made via corresponding side feed equipment.

Extrusion took place subsequently on a co-rotating twin screw with downstream strand pelletizing or underwater pelletizing. Granule sizes 0.8 to 3 mm in diameter.

### Preparation Examples

In the examples below, the following composition was prepared by the processes described above. The metallocene waxes used in each case comprised the wax described above.
1) 50% mixture of esters of 2,2,6,6-tetramethylpiperidinol-4-piperidinol with fatty acids
   25% metallocene wax c)
   25% metallocene wax d)
2) 50% mixture of esters of 2,2,6,6-tetramethylpiperidinol-4-piperidinol with fatty acids
   25% metallocene wax b)
   25% metallocene wax d)
3) 50% mixture of esters of 2,2,6,6-tetramethylpiperidinol-4-piperidinol with fatty acids
   33% metallocene wax c)
   17% metallocene wax d)
4) 60% polymer of 2,2,4,4-tetramethyl-7-oxa-3,20-diazadispiro-[5.1.1.12]heneicosan-21-one and epichlorohydrin
   40% metallocene wax c)
5) 60% polymer of 2,2,4,4-tetramethyl-7-oxa-3,20-diazadispiro-[5.1.1.12]heneicosan-21-one and epichlorohydrin
   32% metallocene wax c)
   8% LDPE MFI 2 g/10 min
6) 50% polymer of 2,2,4,4-tetramethyl-7-oxa-3,20-diazadispiro-[5.1.1.12]heneicosan-21-one and epichlorohydrin
   40% metallocene wax c)
   10% LDPE MFI 2 g/10 min
7) 25% polymer of 2,2,4,4-tetramethyl-7-oxa-3,20-diazadispiro-[5.1.1.12]heneicosan-21-one and epichlorohydrin
   50% metallocene wax c)
   25% metallocene wax d)
8) 46.6% polymer of 2,2,4,4-tetramethyl-7-oxa-3,20-diazadispiro-[5.1.1.12]heneicosan-21-one and epichlorohydrin
   23.3% 2-hydroxy-4-n-octyloxybenzophenone
   30.0% metallocene wax b)
9) 30% mixture of 2,2,4,4-tetramethyl-20-(β-myristyl- and lauryl-oxycarbonyl)ethyl-7-oxa-3,20-diazadispiro[5.1.1.12]heneicosan-21-one
   70% metallocene wax c)

### Use Examples

The additive combinations according to preparation examples 1 to 19 were partly premixed and extruded in a co-rotating twin screw with a special screw structure and also with a low temperature profile. In different polymers this led to reduced color changes, higher thermal stabilities and increased stability toward UV light, and also to an improvement in quality.

1. An active substance composition comprising
i) one or more UV stabilizers,
ii) one or more metallocene polyolefin waxes,
iii) optionally, one or more waxes selected from the group consisting of polar and apolar nonmetallocene polyolefin waxes, and
iv) optionally, one or more homopolymers of ethylene, homopolymers of propylene, copolymers of ethylene, copolymers of ethylene or a mixture thereof,
wherein the active substance composition comprises UV stabilizers in an amount of at least 10% to 90% by weight and at least 10% by weight of wax, based in each case on the total weight of the composition.

2. The composition as claimed in claim 1, wherein the one or more metallocene polyolefin waxes contains at least 50% by weight of polypropylene metallocene wax, based on the weight of the wax fraction.

3. The composition as claimed in claim 1, wherein the one or more homopolymers of ethylene, homopolymers of propylene, copolymers of ethylene, copolymers of ethylene or a mixture thereof melt at a temperature in the range from 80 to 170° C.

4. The composition as claimed in claim 1, wherein the one or more metallocene polyolefin waxes possess a dropping point in the temperature range between 80 and 170° C. and a melt viscosity, measured at a temperature of 170° C., in the range from 40 to 80 000 mPa·s.

5. The composition as claimed in claim 1, comprising 10% to 90% by weight, of the one or more metallocene polyolefin waxes, 0.1% to 30% by weight, of the one or more nonmetallocene waxes and/or one or more homopolymers of ethylene, homopolymers of propylene, copolymers of ethylene, copolymers of ethylene or a mixture thereof, 10% to 90% by weight, of one or more UV stabilizers, and 0% to 30% by weight of at least one filler or additive.

6. The composition as claimed in claim 1, wherein the one or more nonmetallocene polyolefin waxes are selected from the group consisting of oxidized and nonoxidized waxes, wherein the oxidized and nonoxidized waxes possess a dropping point in the range from 90 to 130° C. and a viscosity of less than 30 000 mPa·s, measured at 140° C.

7. The composition as claimed in claim 1, comprising, in addition to the one or more metallocene polyolefin waxes, one or more metallocene copolymer waxes of propylene, ethylene, or both and 0.1% to 50% by weight of one or more further monomers selected from group consisting of ethylene and branched or unbranched 1-alkenes having 4 to 20 carbon atoms.

8. A process for preparing a composition as claimed in claim 1, comprising the step of mixing the individual components cold and homogenizing the individual components in an extruder or compounder to form a mixture.

9. The process as claimed in claim 8, wherein in the mixing step, the individual components are in the form of granules, flakes, powders or a fine-grain mixture.

10. The process as claimed in claim 8, wherein the individual components further comprise one or more UV stabilizers and wherein the UV stabilizers are used in liquid form.

11. The process as claimed in claim 8, wherein the homogenizing step is followed by pelletizing the mixture, and wherein the palletizing step is selected from the group consisting of strand and die-face pelletizing, hot cutting pelletizing and underwater pelletizing.

12. A light-resistant plastic material or plastic-material part comprising the active substance composition as claimed in claim 1.

13. A stabilizer for a natural, semisynthetic or synthetic polymer against the harmful influence of high-energy radiation such as light or UV, and against heat, degradation by oxygen, or other degradation processes comprising an active substance composition as claimed in claim 1.

14. The stabilizer as claimed in claim 13, wherein polymer is selected from the group consisting of: polyolefins, ethylene-vinyl acetate copolymers (EVA), styrene-acrylonitrile copolymers (SAN), polyvinyl chloride (PVC), polyamide (PA), polyethylene glycol terephthalate (PET), polybutylene glycol terephthalate (PBT) copolyesters of polybutylene glycol terephthalate, acrylonitrile-butadiene-styrene copolymers (ABS), polycarbonate (PC).

15. The composition as claimed in claim 1, wherein the one or more metallocene polyolefin waxes possess a dropping point in the temperature range between 80 and 170° C. and a melt viscosity, measured at a temperature of 170° C., from 45 to 35 000 mPa·s.

16. The composition as claimed in claim 1, wherein the one or more metallocene polyolefin waxes possess a dropping point in the temperature range between 80 and 170° C. and a melt viscosity, from 50 to 10 000 mPa·s.

17. The composition as claimed in claim 1, comprising 15% to 85% by weight, of the one or more metallocene polyolefin waxes, 0% to 25% by weight, of the one or more nonmetallocene waxes and/or one or more homopolymers of ethylene, homopolymers of propylene, copolymers of ethylene, copolymers of ethylene or mixture thereof, 15% to 85% by weight, of one or more UV stabilizers, and 0% to 30% by weight of at least one filler or additive.
